(19) United States
(12) Patent Application Publication
(10) Pub. No.: US 2011/0074719 A1
(43) Pub. Date: Mar. 31, 2011

(54) GESTURE DETECTING METHOD FOR TOUCH PANEL

(75) Inventors: Herng-Ming Yeh, Taoyuan County (TW); Yi-Ta Chen, Hsinchu City (TW)

(73) Assignee: Higgstec Inc., Taoyuan County (TW)

(21) Appl. No.: 12/892,002

(22) Filed: Sep. 28, 2010

(30) Foreign Application Priority Data
Sep. 30, 2009 (TW) 098133133

(51) Int. Cl. G06F 3/041

(52) U.S. Cl. 345/173

(57) ABSTRACT

A gesture detecting method for a touch panel is provided. First, a command mode of the touch panel is established based on a hop touch with fingers sequentially touching the touch panel and staying for a while. Then, a gesture is determined according to an eventually detected touch result of a single-point or multipoint touch, i.e., a detected moving track of the touch points, so as to generate and transmit a gesture instruction.

### CROSS-REFERENCES TO RELATED APPLICATIONS

This non-provisional application claims priority under 35 U.S.C. §119(a) on Patent Application No. 98133133 filed in Taiwan, R.O.C. on 2009/9/30, the entire contents of which are hereby incorporated by reference.

### BACKGROUND

1. Technical Field

The disclosure relates to a touch panel, and more particularly to a gesture detecting method for a touch panel.

2. Related Art

In the year of 2007, Apple Company produced a capacitive touch phone iPhone, and made a record of selling one million sets within 74 days in the mobile phone market. This record was broken by Apple Company's iPhone3GS, newly produced in 2009, which set a record of selling one million sets within three days. These figures indicate that touch panel technology has already become a success in the market.

The capacitive touch panel applied in the iPhone is a projective capacitive touch panel (PCTP), which has an electrode structure formed by a plurality of X-axis electrodes on a single layer and a plurality of Y-axis electrodes on a single layer arranged alternately, and detects the touch of an object through X-axis and Y-axis scanning. The technical requirement of multipoint touch is achieved, and the multipoint touch panel can accomplish many motions which cannot be accomplished by single-point touch technology.

The aforementioned multipoint touch function is quite popular among consumers. However, the surface capacitive touch (SCT) panel, the technology of which is relatively mature, can only provide a single-point touch function. SCT panel is therefore inapplicable to products using multipoint touch. Furthermore the cost structure of the SCT panel is lower than that of the PCTP due to the configuration and manufacturing process of the SCT panel, so that if a multipoint touch detecting function can be achieved using SCT panel, then SCT panel may become highly competitive.

FIG. 1 is the basic structure of the SCT panel. Electrodes N1, N2, N3, and N4 on four corners of a touch panel 1 provide different voltages, so as to form electric fields distributed uniformly on a surface of the panel. In a static state, the electric fields generated by the voltages provided to serially-connected electrodes 12, 14, 16, and 18 are distributed uniformly, in which the electric fields distributed uniformly along the X-axis and the Y-axis are sequentially formed, and a stable static capacitance is formed between an upper electrode layer and a lower electrode layer (not shown). As the electrode layer is designed with high impedance, its power consumption is rather low. When an object touches a touch point T1 on the touch panel to causing a capacitive effect, the touch panel generates a current. Based on the electric fields distributed uniformly along the X-axis and the Y-axis generated by the supplied voltages, the magnitude of the currents generated at four corners is compared by using a connector 20, so as to calculate coordinates of the touch point T1 on the X-axis and Y-axis. In the current technology, as for a touch motion produced by multiple points is still regarded by the SCT panel as a single-point touch.

Furthermore, in the multipoint touch applications, only one gesture instruction is finally issued, regardless of the number of points in the multipoint touch. Therefore, if a single-point touch is used to simulate a multipoint touch gesture instruction, the SCT panel generally applied to single-point touch applications can be used to enable a user to output a touch gesture instruction in a multipoint manner. In addition to the capacitive touch panel, the resistive touch panel also has the same problem. Therefore, enabling resistive touch panels and capacitive touch panels to convert a multipoint touch into a gesture instruction to be output remains a problem waiting to be solved by many touch panel manufactures.

### SUMMARY

In order to solve the above problem in the prior art, the disclosure is directed to a gesture detecting method for a touch panel, which includes the steps of: detecting a first click of a first object at a first touch coordinate; detecting a second click of a second object at a second touch coordinate; when the first click and the second click are hop clicks and the second object stays still at the second touch coordinate for exceeding a period of dwell time after making the second click, entering a gesture detecting mode; when it is detected that the second object leaves the second touch coordinate, detecting a moving track of the second object within a default time; and determining a gesture according to a first number of the first click, a second number of the second click, and the moving track.

The disclosure is also directed to a gesture detecting method for a touch panel, which includes: detecting a first click of a first object at a first touch coordinate; detecting a second click of a second object at a second touch coordinate; when the first click and the second click are hop clicks, entering a gesture detecting mode; when it is detected that the second object leaves the second touch coordinate, detecting a moving track of the second object within a default time; and determining a gesture according to a number of the first click, a number of the second click, and the moving track.

The disclosure is further directed to a gesture detecting method for a touch panel, which includes: detecting a first single click of a first object at a first touch coordinate; detecting a second single click of a second object at a second touch coordinate; when the first single click and the second single click are hop clicks and the second object stays still at the second touch coordinate for exceeding a period of dwell time after making the second single click, entering a gesture detecting mode; when it is detected that the second object leaves the second touch coordinate, detecting a moving track of the second object within a default time; and determining a gesture according to the moving track.

### BRIEF DESCRIPTION OF THE DRAWINGS

FIG. 1 is a schematic view of touch detection of a capacitive touch panel in the prior art;

FIGS. 2A to 2I are schematic views of gesture detecting modes and moving tracks of a touch panel according to the disclosure;

FIGS. 3A to 3D are schematic views of gesture detecting modes and zoom-in/out moving tracks of the touch panel according to the disclosure;

FIGS. 4A to 4D are schematic views of gesture detecting modes and rotation moving tracks of the touch panel according to the disclosure;

FIG. 5 is a flow chart of an embodiment of a gesture detecting method for a touch panel according to the disclosure; and

FIG. 6 is a flow chart of another embodiment of a gesture detecting method for a touch panel according to the disclosure.

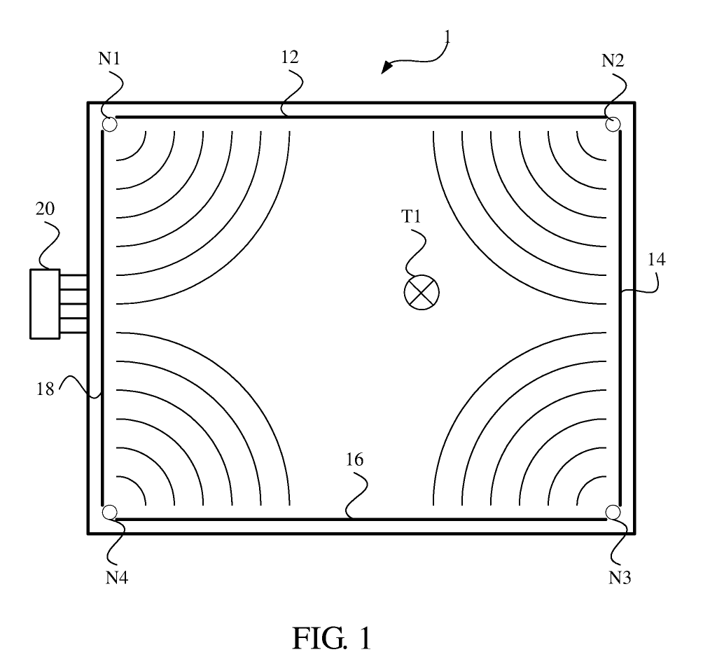

### DETAILED DESCRIPTION

The disclosure is mainly characterized by the fact that a gesture detecting mode of a touch panel is established based on a hop touch with fingers sequentially touching the touch panel. That is, when the user intends to enter the gesture detecting mode and control the touch panel with several fingers, the method of the disclosure may be used to operate the touch panel to obtain a desired gesture instruction.

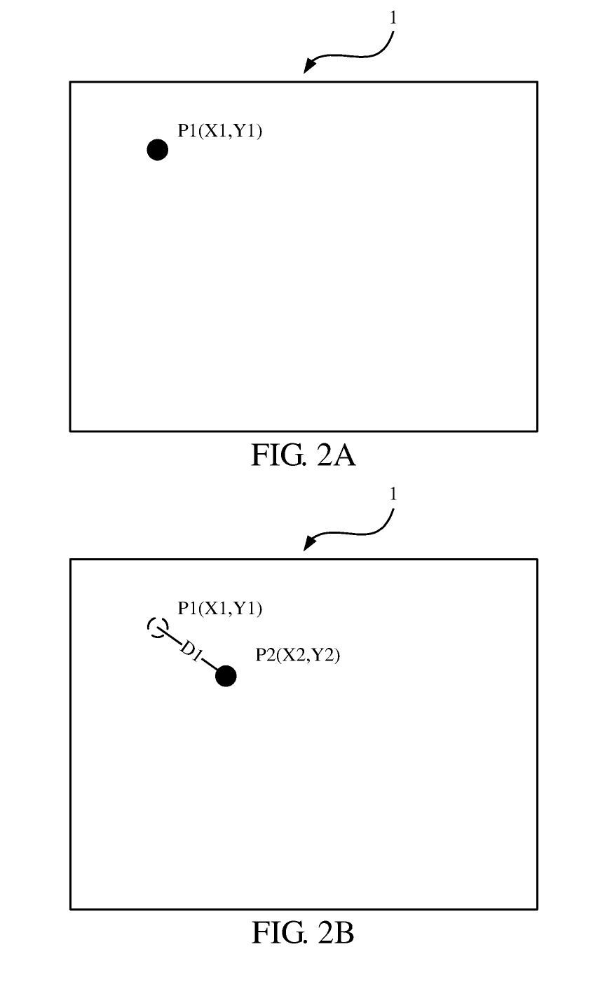

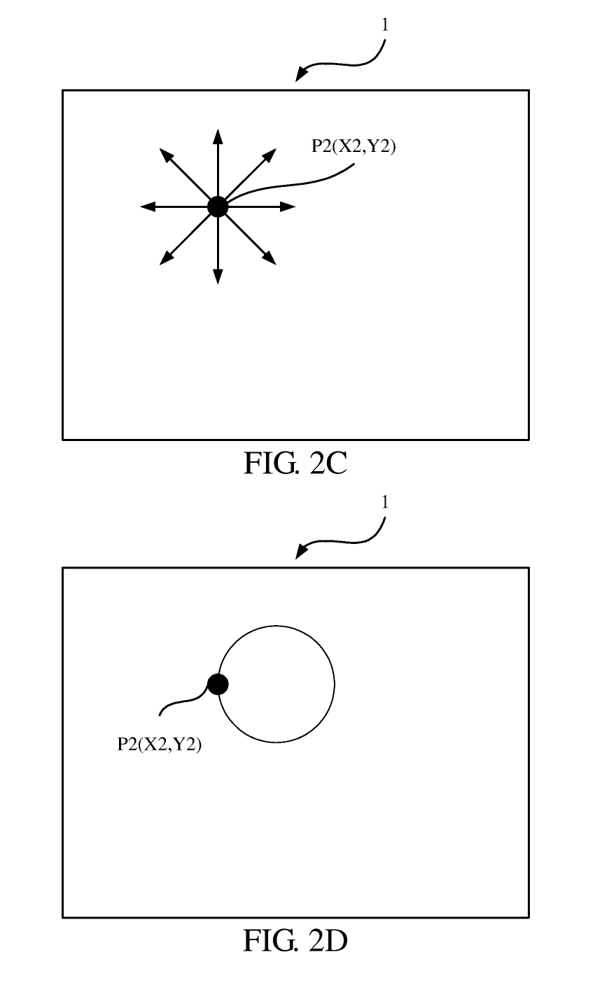

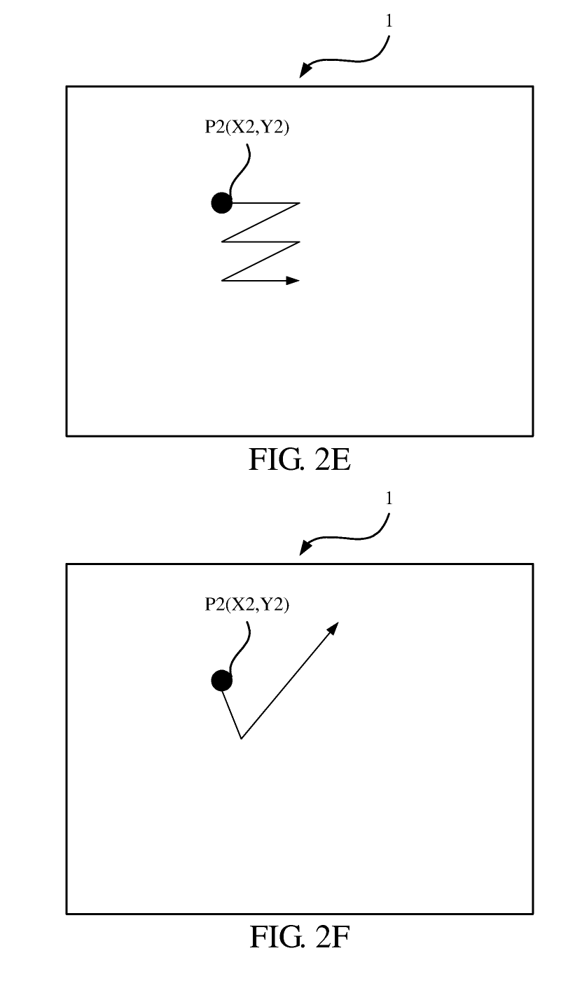

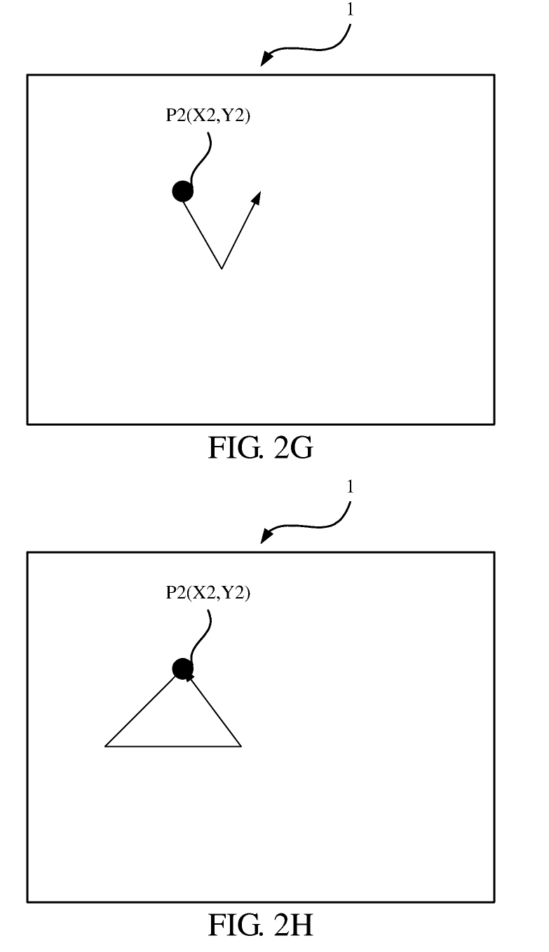

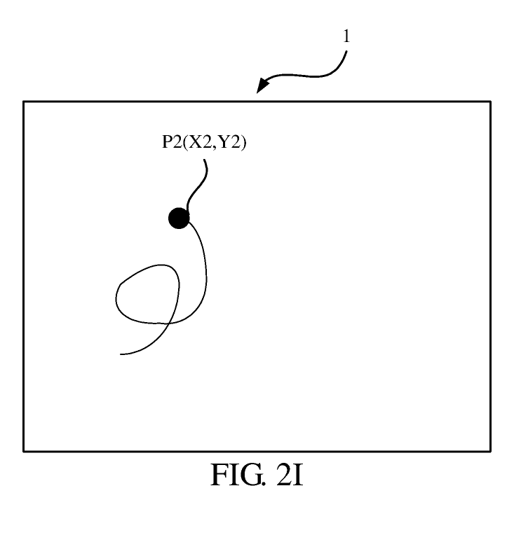

FIGS. 2A to 2H are schematic views of gesture detecting modes and moving tracks of a capacitive touch panel according to the disclosure. FIGS. 2A and 2B are schematic views of touch points P1(X1, Y1) and P2(X2, Y2) detected by a touch panel 1. When moving from P1(X1, Y1) to P2(X2, Y2), the touch point moves for a distance of D1 at a moving speed of V1. If the moving speed V1 exceeds a default speed, i.e., the touch point detected by the touch panel hops from P1 to P2, the following two circumstances may exist: I. the hop touch is produced by touching the touch panel with a first finger and subsequently touching the touch panel with a second finger, in which the touch point detected at a second time is a midpoint of the touch point of the first finger and the touch point of the second finger; and II. the hop touch is produced by touching the touch panel with a first finger and subsequently touching the touch panel with a second finger while removing the first finger at the same time.

The disclosure may be applicable to both the above two circumstances, and the key point is that any motion for producing the hop touch is regarded as a starting point for entering the gesture detecting mode in the disclosure. Certainly, instances of continuous touches with three fingers, four fingers, or five fingers may also be determined in the same manner. Although the surface capacitive touch (SCT) panel only detects one touch point corresponding to different continuous touches, a hop-touch result generated by the continuous touch can be used for determination, and the disclosure utilizes the part for determination as a starting point for entering the gesture detecting mode.

Once entering the gesture detecting mode, the system needs to recognize a “single-finger” or “multi-finger” gesture of the user, i.e., to determine a gesture according to a track after entering the “gesture detecting mode”, in which the track is a final result generated by a single finger or multiple fingers at the same time, that is, an eventually-detected integrated result generated with the touch point as a single finger or multiple fingers. No matter how many fingers are used to produce the touch motion, the moving track is used for determining the gesture.

Next, please refer to FIGS. 2C to 2H, in which several examples of moving tracks are described. For example, FIG. 2C is moving tracks in upward, downward, leftward, rightward, left-upward, left-downward, right-upward, and right-downward directions, which is the moving track of the last hop-touch point detected by the touch panel 1, that is, the touch point P2(X2, Y2).

FIG. 2D is a circle-drawing moving track, which is similarly the moving track of the last hop-touch point detected by the touch panel 1, that is, the touch point P2(X2, Y2). FIG. 2E is a moving track of repeatedly moving back and forth, which is similarly the moving track of the last hop-touch point detected by the touch panel 1, that is, the touch point P2(X2, Y2). FIG. 2F is a moving track of a non-isometric checkmark, which is similarly the moving track of the last hop-touch point detected by the touch panel 1, that is, the touch point P2(X2, Y2). FIG. 2G is a moving track of an approximate isometric checkmark, which is similarly the moving track of the last hop-touch point detected by the touch panel 1, that is, the touch point P2(X2, Y2). FIG. 2H is a triangular moving track, which is similarly the moving track of the last hop-touch point detected by the touch panel 1, that is, the touch point P2(X2, Y2), and the triangle is simply an ordinary triangle. FIG. 2I is a single-helical moving track, which is similarly the moving track of the last hop-touch point detected by the touch panel 1, that is, the touch point P2(X2, Y2).

In addition to the track examples shown in FIGS. 2C to 2I, other moving tracks may also be pre-defined and applied in the disclosure, which include: a gesture of dragging up corresponding to an upward track; a gesture of dragging down corresponding to a downward track; a gesture of moving forward corresponding to a leftward track; a gesture of moving back corresponding to a rightward track; a gesture of delete corresponding to a left-upward track; a gesture of undoing corresponding to a left-downward track; a gesture of copying corresponding to a right-upward track; a gesture of pasting corresponding to a right-downward track; a gesture of redoing corresponding to a counterclockwise rotation track; a gesture of undoing corresponding to a clockwise rotation track; a gesture of checking-off corresponding to a non-isometric checkmark track; a gesture of inserting corresponding to an isometric checkmark track; a gesture of erasing content corresponding to a back-and-forth moving track; a gesture of cutting corresponding to a single-helical track; a gesture of inserting corresponding to a triangular track; and an application specific gesture corresponding to a circle-drawing track; a gesture of copying corresponding to a double-helical track; a gesture of pasting and inserting corresponding to an inverted checkmark track; a gesture of pasting corresponding to a double-circle-drawing track; and a gesture of an action item corresponding to a star-shaped track. Other gestures may also be independently defined by designers.

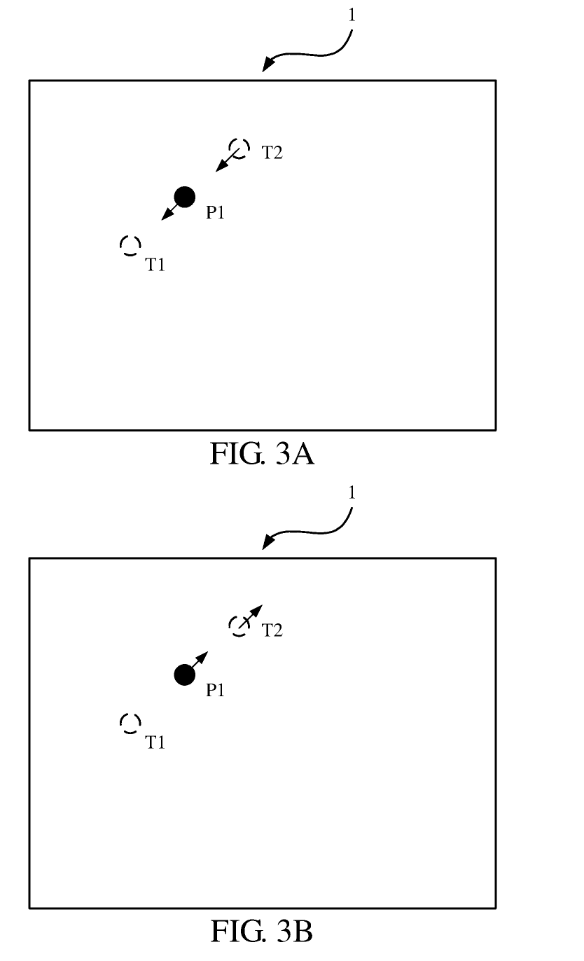

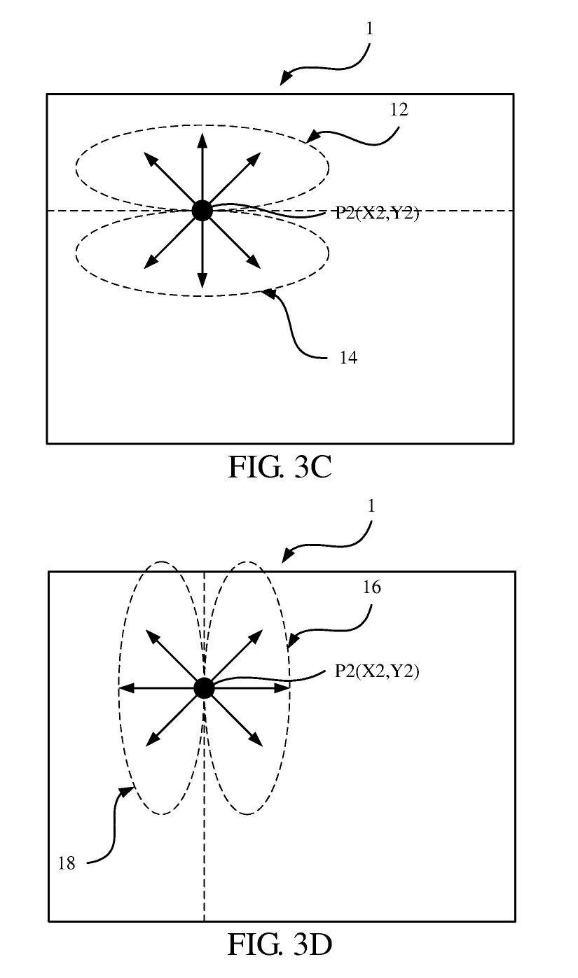

In addition to the gestures shown in FIGS. 2A to 2I, the zoom-in/out gestures commonly used in the multipoint touch may also be simulated in the disclosure. FIGS. 3A to 3D are schematic views of gesture detecting modes and zoom-in/out moving tracks of the touch panel according to the disclosure. The touch panel detects an integrated touch point P1 of a first touch point T1 and a second touch point T2 of the fingers, that is, a midpoint of the first touch point T1 and the second touch point T2. Usually, the user performs the zoom-in/out motions with the index finger and the thumb. In order to achieve the zoom-in/out effects, the following possible finger motions may be adopted: I. the thumb stands still while the index finger performs a zoom-in/out motion; II. the index finger stands still while the thumb performs a zoom-in/out motion; and III. the thumb and the index finger perform a zoom-in/out motion at the same time. Generally, regardless of the above three circumstances, the moving speeds of the thumb and the index finger are slightly different.

Please refer to FIG. 3A, in which a motion of T1 for representing the thumb and T2 for representing the index finger is shown. At this time, T2 moves towards T1, and the integrated touch point P1 moves towards T1 accordingly, which is a zoom-out motion.

Please refer to FIG. 3B, in which another motion of T1 for representing the thumb and T2 for representing the index finger is shown. At this time, T2 moves away from T1, and the integrated touch point P1 moves away from T1 accordingly, which is a zoom-in motion.

As known from FIGS. 3A and 3B, basically, due to a speed difference between the finger motions of the user, the zoom-in/out gestures may involve inverse moving trends. By using such a feature, the disclosure uses a single-point moving track to simulate zoom-in/out gestures between two points. Specifically, the disclosure uses a mean line to divide a two-dimensional space of the touch panel, so as to obtain two direction dimensions, namely, a first direction and a first reverse direction. Please refer to FIG. 3C, in which according to a first inverse trend definition of the disclosure, a horizontal line is adopted to divide the touch panel, so as to obtain a direction having an upward trend and a direction having a downward trend, and thus the moving track corresponding to the gesture is also divided into a track 12 having an upward trend and a track 14 having a downward trend. The track 12 having an upward trend may be defined to be corresponding to the zoom in effect, while the track 14 having a downward trend may be defined to be corresponding to the zoom out effect. Alternatively, the track 12 having an upward trend may be defined to be corresponding to the zoom out effect, while the track 14 having a downward trend may be defined to be corresponding to the zoom in effect.

Please refer to FIG. 3D, in which according to a second inverse trend definition of the disclosure, i.e., a definition in the left-right direction, a vertical line is adopted to divide the moving track corresponding to the gesture into a track 18 having a leftward trend and a track 16 having a rightward trend. The track 18 having a leftward trend may be defined to be corresponding to the zoom in effect, while the track 16 having a rightward trend may be defined to be corresponding to the zoom out effect. Alternatively, the track 18 having a leftward trend may be defined to be corresponding to the zoom out effect, while the track 16 having a rightward trend may be defined to be corresponding to the zoom in effect. The two direction dimensions may certainly also be divided using an oblique line.

Therefore, when a zoom-in/out motion on the touch panel with fingers is intended, a single-point simulation is implemented through the disclosure.

Certainly, in actual operations performed by the user the zoom-in/out simulation of the disclosure may be accomplished through different motions. For example, the zoom-in/out simulation may be achieved by moving a single finger after making a hop motion by using the single finger. The implementation of the zoom-in/out simulation depends on the way that the user employs the gesture definition of the disclosure.

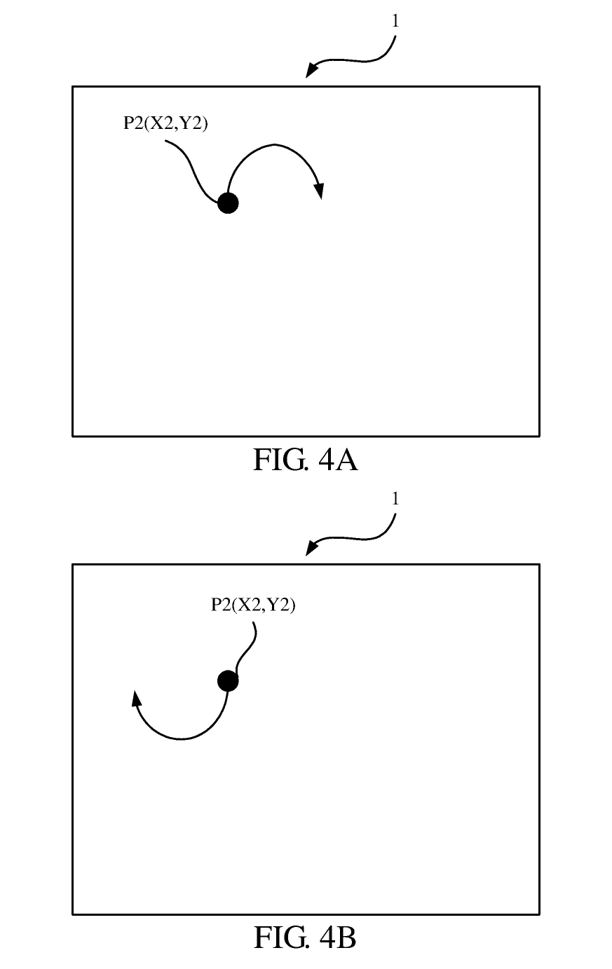

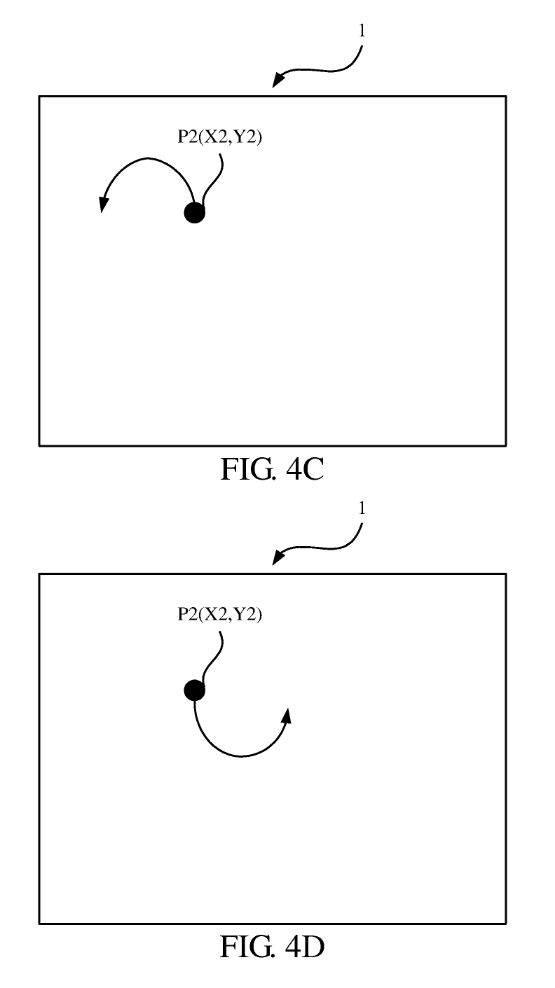

Furthermore, another commonly used multipoint touch gesture is rotation, which may also be simulated through the disclosure. FIGS. 4A to 4D are schematic views of gesture detecting modes and rotation moving tracks of the touch panel according to the disclosure. FIGS. 4A and 4B are two types of clockwise rotations, namely, upward clockwise rotation and downward clockwise rotation. FIGS. 4C and 4D are two types of counterclockwise rotations, namely, upward counterclockwise rotation and downward counterclockwise rotation. The four types of rotation tracks may all be simulated in a single-point manner. Similarly, regardless of the motions produced with two or three fingers, the eventual single-point simulation may achieve the effect of a multipoint simulation.

In the disclosure the gesture detecting mode may be entered in various manners: I. implementing a hop click after making a single click; II. implementing a hop click after making a double-click or other multiple consecutive clicks like three consecutive clicks or four consecutive clicks, in which the multiple consecutive clicks are performed at the same point, and the definition of the same point may be expanded to points quite close to each other. III. implementing a hop click after making a single click, and then dwelling for a default time; and IV. implementing a hop click after making a double-click or other multiple consecutive clicks such as three consecutive clicks or four consecutive clicks, and then dwelling for a default time, in which the multiple consecutive clicks are performed at the same point, and the definition of the same point may be expanded to points quite close to each other. In addition, other methods may also be adopted, including: V. implementing multiple consecutive hop clicks after making a single click; VI. implementing multiple consecutive hop clicks after making a double-click or other multiple consecutive clicks like three consecutive clicks or four consecutive clicks, in which the multiple consecutive clicks are performed at the same point, and the definition of the same point may be expanded to points quite close to each other; VII. implementing multiple consecutive hop clicks after making a single click, and then dwelling for a default time; and VIII. implementing multiple consecutive hop clicks after a double-click or other multiple consecutive clicks such as three consecutive clicks or four consecutive clicks, and then dwelling for a default time, in which the multiple consecutive clicks are performed at the same point, and the definition of the same point may be expanded to points quite close to each other.

The touch panel 1 may detect all of these motions. Different clicks or consecutive clicks may be used together with the same track or track trend to serve as different gesture instructions. The above eight circumstances are all starting points for entering the gesture detecting mode, and the subsequent tracks may be the same, but different gesture instructions are output, thereby obtaining eight types of gesture instructions. The consecutive clicks may also be classified into several types, so as to obtain diversified gesture instructions.

For example, the gesture detecting mode I and the gesture detecting mode V adopt a zoom-in/out track trend definition, and the following circumstances are included: a gesture of zooming in corresponding to an upward track; a gesture of zooming out corresponding to a downward track; a gesture of rotating clockwise of a frame corresponding to a clockwise rotation track; and a gesture of rotating counterclockwise of a frame corresponding to a counterclockwise rotation track. Alternatively, the following circumstances are defined: a gesture of zooming out corresponding to an upward track; a gesture of zooming in corresponding to a downward track; a gesture of rotating clockwise of a frame corresponding to a clockwise rotation track; and a gesture of rotating counterclockwise of a frame corresponding to a counterclockwise rotation track. Alternatively, the following circumstances are defined: a gesture of zooming in corresponding to a leftward track; a gesture of zooming out corresponding to a rightward track; a gesture of rotating clockwise of a frame corresponding to a clockwise rotation track; and a gesture of rotating counterclockwise of a frame corresponding to a counterclockwise rotation track. Alternatively, the following circumstances are defined: a gesture of zooming in corresponding to a rightward track; a gesture of zooming out corresponding to a leftward track; a gesture of rotating clockwise of a frame corresponding to a clockwise rotation track; and a gesture of rotating counterclockwise of a frame corresponding to a counterclockwise rotation track.

The mode (II) of implementing a hop click after making a double click and the mode (VI) of implementing a hop click after making a double click and then dwelling for a default time both adopt the tracks and gesture definitions in FIGS. 2A to 2I.

Alternatively, the above two gesture definitions may be exchanged, which is described below with a flow chart.

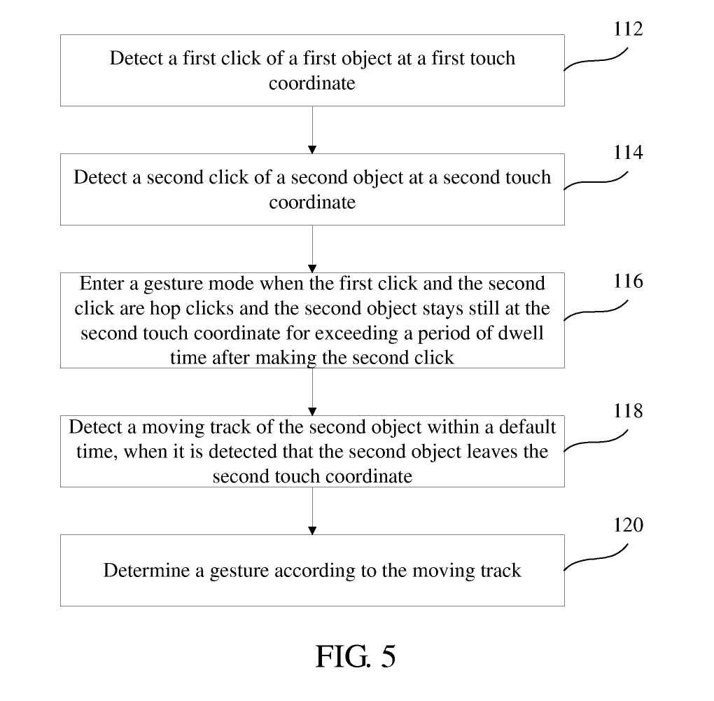

FIG. 5 is a flow chart of an embodiment of a gesture detecting method for a touch panel according to the disclosure. The method includes the following steps.

In Step 112, a first click of a first object at a first touch coordinate is detected.

In Step 114, a second click of a second object at a second touch coordinate is detected.

In Step 116, when the first click and the second click are hop clicks and the second object stays still at the second touch coordinate for exceeding a period of dwell time after making the second click, a gesture detecting mode is entered.

In Step 118, when it is detected that the second object leaves the second touch coordinate, a moving track of the second object is detected within a default time.

In Step 120, a gesture is determined according to the moving track.

Step 112 and Step 114 are steps for determining the gesture detecting modes I to VIII, and Step 116 is the step for determining the gesture detecting modes I to VI.

Furthermore, Step 116 further includes: exiting the gesture detecting mode, if it is detected that the second object stays still at the second touch coordinate for exceeding a period of maximum dwell time (for example, 3 seconds), after making the click. This usually happens when the user does not intend to perform any specific gesture of the disclosure or is unaware of which gesture to perform, so the disclosure will determine other action.

In addition to these steps, the following step may also be performed, which includes: outputting a gesture instruction according to the gesture; or outputting a coordinate of the second object; or outputting a gesture mode instruction.

The step of determining the gesture according to the moving track further includes: comparing the moving track with a plurality of default moving tracks stored in a database, so as to determine the gesture. The comparison may be made by using fuzzy matching or trend analysis.

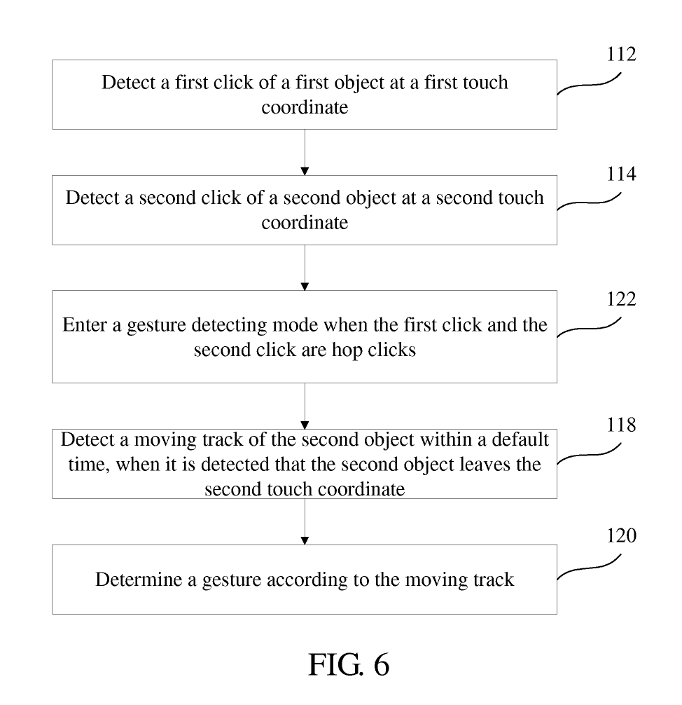

FIG. 6 is a flow chart of another embodiment of a gesture detecting method for a touch panel according to the disclosure. The method includes the following steps.

In Step 112, a first click of a first object at a first touch coordinate is detected.

In Step 114, a second click of a second object at a second touch coordinate is detected.

In Step 122, when the first click and the second click are hop clicks, a gesture detecting mode is entered.

In Step 118, when it is detected that the second object leaves the second touch coordinate, a moving track of the second object is detected within a default time.

In Step 120, a gesture is determined according to the moving track.

Step 112 and Step 114 are steps for determining the gesture detecting modes I to VIII, and Step 122 is the step for determining the gesture detecting modes V to VIII.

In addition, the difference between the processes in FIG. 5 and FIG. 6 lies in Step 116 and Step 122. Step 116 includes the determination of a period of dwell time, whereas Step 122 does not have such a function. That is to say, the process in FIG. 5 needs to wait for a period of dwell time of, for example, 0.1 to 3 seconds, whereas the process in FIG. 6 does not need to wait but directly enters the gesture detecting mode for the subsequent determination operation.

While the disclosure has been described by the way of example and in terms of the preferred embodiments, it is to be understood that the invention need not to be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A gesture detecting method for a touch panel, comprising the steps of:
detecting a first click of a first object at a first touch coordinate;
detecting a second click of a second object at a second touch coordinate;
entering a gesture detecting mode, when the first click and the second click are hop clicks and the second object stays at the second touch coordinate for exceeding a period of dwell time after making the second click;
detecting a moving track of the second object within a default time, after detecting the second object leaves the second touch coordinate; and
determining a gesture according to a first number of the first click, a second number of the second click, and the moving track.

2. The method according to claim 1, further comprising the step of:
exiting the gesture detecting mode, when it is detected that the second object stays still at the second touch coordinate for exceeding a period of maximum dwell time after making the second click.

3. The method according to claim 2, wherein the period of maximum dwell time is in a range of 3 to 5 seconds, and the period of dwell time is in a range of 0.1 to 3 seconds.

4. The method according to claim 1, further comprising the steps of:
outputting a gesture instruction according to the gesture;
outputting a coordinate of the second object; and
outputting a gesture detecting mode instruction.

5. The method according to claim 1, wherein the moving track is selected from a group consisting of a first direction track, a first reverse direction track, a counterclockwise rotation track, and a clockwise rotation track, and the first direction and the first reverse direction are two direction dimensions obtained by dividing a two-dimensional space of the touch panel with a mean line.

6. The method according to claim 5, wherein gestures corresponding to the moving tracks comprise:
a gesture of zooming in corresponding to the first direction track;
a gesture of zooming out corresponding to the first reverse direction track;
a gesture of rotating clockwise of a frame corresponding to the clockwise rotation track; and
a gesture of rotating counterclockwise of a frame corresponding to the counterclockwise rotation track.

7. The method according to claim 6, wherein the mean line is a horizontal line, and the first direction track and the first reverse direction track are selected from circumstances such that: the first direction track is a track having an upward trend, while the first reverse direction track is a track having a downward trend; and the first direction track is a track having a downward trend, while the first reverse direction track is a track having an upward trend.

8. The method according to claim 6, wherein the mean line is a vertical line, and the first direction track and the first reverse direction track are selected from circumstances such that: the first direction track is a track having a leftward trend, while the first reverse direction track is a track having a rightward trend; and the first direction track is a track having a rightward trend, while the first reverse direction track is a track having a leftward trend.

9. The method according to claim 1, wherein gestures corresponding to the moving tracks comprise:
a gesture of dragging up corresponding to an upward track;
a gesture of dragging down corresponding to a downward track;
a gesture of moving forward corresponding to a leftward track;
a gesture of moving back corresponding to a rightward track;
a gesture of delete corresponding to a left-upward track;
a gesture of undoing corresponding to a left-downward track;
a gesture of copying corresponding to a right-upward track;
a gesture of pasting corresponding to a right-downward track;
a gesture of redoing corresponding to a counterclockwise rotation track;
a gesture of undoing corresponding to a clockwise rotation track;
a gesture of checking-off corresponding to a non-isometric checkmark track;
a gesture of inserting corresponding to an isometric checkmark track;
a gesture of inserting corresponding to a triangular track;
a gesture of erasing content corresponding to a back-and-forth moving track;
a gesture of cutting corresponding to a single-helical track;
a gesture of copying corresponding to a double-helical track;
a gesture of pasting and inserting corresponding to an inverted checkmark track;
an application specific gesture corresponding to a circle-drawing track;
a gesture of pasting corresponding to a double-circle-drawing track; and
a gesture of an action item corresponding to a star-shaped track.

10. A gesture detecting method for a touch panel, comprising the steps of:
detecting a first click of a first object at a first touch coordinate;
detecting a second click of a second object at a second touch coordinate;
entering a gesture detecting mode, when the first click and the second click are hop clicks;
detecting a moving track of the second object within a default time, when it is detected that the second object leaves the second touch coordinate; and
determining a gesture according to a first number of the first click, a second number of the second click, and the moving track.

11. The method according to claim 10, wherein the moving track is selected from a group consisting of following tracks, and the gesture corresponding to the moving track is as follows:
a gesture of zooming in corresponding to a first direction track;
a gesture of zooming out corresponding to a first reverse direction track, wherein the first direction and the first reverse direction are two direction dimensions obtained by dividing a two-dimensional space of the touch panel with a mean line;
a gesture of rotating clockwise of a frame corresponding to a clockwise rotation track; and
a gesture of rotating counterclockwise of a frame corresponding to a counterclockwise rotation track.

12. The method according to claim 11, wherein the mean line is a horizontal line, and the first direction track and the first reverse direction track are selected from below: the first direction track is a track having an upward trend, while the first reverse direction track is a track having a downward trend; and the first direction track is a track having a downward trend, while the first reverse direction track is a track having an upward trend.

13. The method according to claim 11, wherein the mean line is a vertical line, and the first direction track and the first reverse direction track are selected from below: the first direction track is a track having a leftward trend, while the first reverse direction track is a track having a rightward trend; and the first direction track is a track having a rightward trend, while the first reverse direction track is a track having a leftward trend.

14. A gesture detecting method for a touch panel, comprising the steps of:
detecting a first single click of a first object at a first touch coordinate;
detecting a second single click of a second object at a second touch coordinate;
entering a gesture detecting mode, when the first single click and the second single click are hop clicks and the second object stays still at the second touch coordinate for exceeding a period of dwell time after making the second single click;
detecting a moving track of the second object within a default time, when it is detected that the second object leaves the second touch coordinate; and
determining a gesture according to the moving track.

15. The method according to claim 14, further comprising the steps of:
exiting the gesture detecting mode when it is detected that the second object stays still at the second touch coordinate for exceeding a period of maximum dwell time after making the second single click.

16. The method according to claim 15, wherein the period of maximum dwell time is in a range of 3 to 5 seconds, and the period of dwell time is in a range of 0.1 to 3 seconds.

17. The method according to claim 14, further comprising the step of:
outputting a gesture instruction according to the gesture;
outputting a coordinate of the second object; and
outputting a gesture detecting mode instruction.

18. The method according to claim 14, wherein the moving track is selected from a group consisting of following tracks, and the gesture corresponding to the moving track is as follows:
a gesture of zooming in corresponding to a first direction track;
a gesture of zooming out corresponding to a first reverse direction track, wherein the first direction and the first reverse direction are two direction dimensions obtained by dividing a two-dimensional space of the touch panel with a mean line;
a gesture of rotating clockwise of a frame corresponding to a clockwise rotation track; and
a gesture of rotating counterclockwise of a frame corresponding to a counterclockwise rotation track.

19. The method according to claim 18, wherein the mean line is a horizontal line, and the first direction track and the first reverse direction track are selected from below: the first direction track is a track having an upward trend, while the first reverse direction track is a track having a downward trend; and the first direction track is a track having a downward trend, while the first reverse direction track is a track having an upward trend.

20. The method according to claim 18, wherein the mean line is a vertical line, and the first direction track and the first reverse direction track are selected from below: the first direction track is a track having a leftward trend, while the first reverse direction track is a track having a rightward trend; and the first direction track is a track having a rightward trend, while the first reverse direction track is a track having a leftward trend.
